(19) United States
(12) Patent Application Publication
(10) Pub. No.: US 2016/0098143 A1
(43) Pub. Date: Apr. 7, 2016

(54) TOUCH PANEL SUBSTRATE

(71) Applicant: Sharp Kabushiki Kaisha, Osaka-shi, Osaka (JP)

(72) Inventors: Kazutoshi KIDA, Osaka-shi (JP); Masayuki MIYAMOTO, Osaka-shi (JP); Motomitsu ITOH, Osaka-shi (JP); Kazuya YOSHIMURA, Osaka-shi (JP)

(73) Assignee: Sharp Kabushiki Kaisha, Osaka-shi, Osaka (JP)

(21) Appl. No.: 14/888,966

(22) PCT Filed: Feb. 24, 2014
(86) PCT No.: PCT/JP2014/054341

§ 371 Date: Nov. 4, 2015

(30) Foreign Application Priority Data
May 29, 2013 (JP) 2013-113380

(51) Int. Cl. G06F 3/041; G06F 3/047; G06F 3/044

(52) U.S. Cl. CPC G06F 3/0416; G06F 3/044; G06F 3/0412; G06F 3/047; G06F 2203/04102; G06F 2203/04107

(57) ABSTRACT

The present invention provides a touch panel substrate capable of preventing a detection circuit from being broken down due to application of electrostatic voltage. The touch panel substrate includes a flexible substrate (20) for electrically connecting sensor electrodes (12) and a touch controller (32) to each other. The flexible electrode (20) has one end connected to a terminal section (13) including terminals. The touch panel substrate is further provided with a shielding electrode (14), on an outer side of the terminal section (13).

### TECHNICAL FIELD

The present invention relates to a touch panel substrate.

### BACKGROUND ART

Recently, widely used as portable telephone devices, laptops, and the like are electronic devices provided with a touch panel substrate which can detect a position of a detection target object in a case where a finger or a pen for input (detection target object) touches or approaches a display surface of a display device. The touch panel substrate is provided on the display surface of the display device in such electronic devices.

For example, an electrostatic capacitive touch panel substrate includes: (a) an electrode layer in which a plurality of first sensor electrodes extending in a first direction and second sensor electrodes extending in a second direction orthogonal to the first direction are formed; and (b) a touch controller for calculating a position of a detection target object on the basis of a change in electrostatic capacitance which is formed between the first sensor electrodes and the second sensor electrodes. Such an electrostatic capacitive touch panel substrate has a problem in that, in a case where an external electrostatic voltage is applied to the sensor electrodes, the electrostatic capacitive touch panel substrate may malfunction or the touch controller may be led to electrostatic breakdown.

Patent Literature 1 discloses a touch pad which has a structure including electrodes and lead layers each individually electrically connected with a corresponding one of the electrodes and which makes it easier to prevent the lead layers from being broken down by an electric discharge even in a case where a potential difference occurs due to electrification between electrodes in an assembly step and/or a storage step. Patent Literature 1 also discloses a method for producing the touch pad.

Further, Patent Literature 2 discloses a touch panel which can reduce false recognition due to malfunction, by blocking electromagnetic noise and static electricity which enter from outside.

FIG. 15 is a schematic view of the touch panel according to Patent Literature 2. (a) of FIG. 15 is a schematic top view of the touch panel, and (b) of FIG. 15 is a cross-sectional view taken along line X-X′ in (a) of FIG. 15.

As illustrated in FIG. 15, a plurality of detection electrodes 205 and wiring electrodes 207 are formed on a surface 203 of a substrate 202 of a touch panel 200 according to Patent Literature 2. The wiring electrodes 207 are electrically connected to the detection electrodes 205 (205a and 205b ) and transmit detection signals to a detection circuit (not illustrated in FIG. 15). Further, the touch panel 200 is provided with a first shielding electrode 208 which is formed on an outer periphery of the substrate 202. This first shielding electrode 208 is connected to GND in order to block noise which enters from outside. The plurality of detection electrodes 205 is formed in a center region of the substrate 202, and constitutes a detection region 204. The wiring electrodes 207 are intensively formed outside the detection region 204 so as to constitute a wiring region 206, and concentrated in a right-side edge area of the substrate so as to constitute a terminal area TA. The first shielding electrode 208 is formed outside a region including the detection region 204 and the wiring region 206, so as to surround the detection region 204 and the wiring region 206. In this configuration, noise which enters from an edge of the substrate 202 is blocked by the first shielding electrode 208, before reaching any of the wiring electrodes 207 and the detection electrodes 205. This makes it possible to reduce false recognition due to malfunction.

### CITATION LIST

### Patent Literatures

Patent Literature 1

Japanese Patent Application Publication, Tokukai, No. 2012-155514 (Publication Date: Aug. 16, 2012)

Patent Literature 2

Japanese Patent Application Publication, Tokukai, No. 2010-218542 (Publication Date: Sep. 30, 2010)

### SUMMARY OF INVENTION

### Technical Problem

However, the first shielding electrode 208 of the touch panel 200 according to Patent Literature 2 is not formed along the entire outer periphery of the substrate 202 so as to completely surround the detection region 204 and the wiring region 206. The first shielding electrode 208 is not formed to an area where the terminal area TA is formed on the outer periphery of the substrate 202. Hence, noise enters from the area where the first shielding electrode 208 is not provided on the outer periphery of the substrate 202. As a result, false recognition due to malfunction may occur and/or a detection circuit (touch controller, not illustrated in FIG. 15) may be broken down.

FIG. 16 is a top view of another example of the touch panel disclosed in Patent Literature 2. In FIG. 16, illustration of the detection electrodes and the wiring electrodes is omitted. In a touch panel 201 illustrated in FIG. 16, the terminal area TA is connected with one end of a first flexible substrate 230. Further, onto the first flexible substrate 230, a signal processing IC 231 is mounted. Furthermore, the other end of the first flexible substrate 230 is connected with a second flexible substrate 232. The second flexible substrate 232 is connected to a touch controller that is not illustrated in FIG. 16. The first flexible substrate 230 is provided with a first shielding electrode 208′ which is formed on top of a terminal area TA of the first flexible substrate 230. The touch panel 201 has the entire outer periphery of the substrate 202 surrounded by the first shielding electrodes 208 and 208′. Accordingly, the touch panel 201 can improve an external magnetic noise blocking effect, as compared with the touch panel 200.

However, the first shielding electrode 208′ is formed on an upper side of the first flexible substrate 230, but not on the substrate 202. Accordingly, it is not possible to sufficiently block the entry of noise which comes around along a surface of the substrate 202 from outside the substrate 202.

Further, the touch panel of Patent Literature 2 uses, as a detection surface, a surface on a side where the detection electrodes 205 of the substrate 202 are formed. Accordingly, static electricity is transferred from user's finger to the detection electrodes 205, and then a voltage caused by the static electricity is applied to a touch controller via the first flexible substrate 230 and the second flexible substrate 232. Consequently, the touch controller will be broken down.

The present invention is attained in view of the above problems. An object of the present invention is to provide a touch panel substrate which can prevent a detection circuit from being broken down due to voltage application of static electricity, by blocking static electricity which is about to enter a sensor electrode formation surface of a substrate.

### Solution to Problem

In order to solve the above problems, a touch panel substrate in accordance with an aspect of the present invention is a touch panel substrate for detecting a position of a detection target object on a detection surface which faces outside, the touch panel substrate including: a substrate provided with a plurality of sensor electrodes; a detection circuit electrically connected to the sensor electrodes; and a relay wiring for electrically connecting the sensor electrodes and the detection circuit to each other, the sensor electrodes being provided on a sensor electrode formation surface of the substrate, the sensor electrode formation surface being a surface on an opposite side of the detection surface, the sensor electrode formation surface being provided with a terminal section including terminals of the sensor electrodes, the relay wiring having one end connected to the terminal section, and the sensor electrode formation surface being provided with a shielding electrode, on an outer side of the terminal section.

### Advantageous Effects of Invention

According to an aspect of the present invention, it is possible to provide a touch panel substrate which can prevent a detection circuit from being broken down due to voltage application of static electricity, by blocking static electricity into a sensor electrode formation surface of a substrate.

### BRIEF DESCRIPTION OF DRAWINGS

FIG. 1 is a cross-sectional view of a touch panel substrate in accordance with Embodiment 1 of the present invention.

FIG. 2 is a cross-sectional view illustrating a connection relation between a first electrode substrate and a touch controller in the touch panel substrate in accordance with Embodiment 1 of the present invention.

FIG. 3 is a cross-sectional view illustrating a connection relation between the first electrode substrate and the touch controller in a case where a flexible substrate is bent.

FIG. 4 is a plan view illustrating a back surface side of a first electrode substrate in accordance with an example of the present invention.

FIG. 5 is a view for illustrating paths of static electricity. (a) of FIG. 5 is a cross-sectional view of a touch panel substrate of a comparative example, which cross-sectional view illustrates a path of static electricity in a case where a first substrate is provided with no shielding electrode. (b) of FIG. 5 is a plan view of the first electrode substrate of the touch panel substrate in accordance with Embodiment 1, which plan view illustrates a path of static electricity in a case where the first substrate is provided with a shielding electrode.

FIG. 6 is a view for illustrating paths of static electricity. (a) of FIG. 6 is a cross-sectional view of a touch panel substrate, as a comparative example, disclosed in Patent Literature 2. (b) of FIG. 6 is a plan view of the first electrode substrate of the touch panel substrate disclosed in Patent Literature 2, which plan view illustrates a path of static electricity in a case where the first substrate is provided with the shielding electrode.

FIG. 7 is a plan view illustrating a back surface side of a first electrode substrate in accordance with another example of the present invention.

FIG. 8 is a plan view illustrating a back surface side of a first electrode substrate in accordance with yet another example of the present invention.

FIG. 9 is a plan view illustrating a back surface side of a first electrode substrate in accordance with yet another example of the present invention.

FIG. 10 is a plan view illustrating a back surface side of a first electrode substrate in accordance with yet another example of the present invention.

FIG. 11 is a view illustrating configurations of shielding electrodes. (a) of FIG. 11 is a plan view illustrating a back surface side of a first electrode substrate in accordance with yet another example of the present invention. (b) of FIG. 11 is a plan view illustrating a back surface side of another first electrode substrate as a comparative example.

FIG. 12 is a cross-sectional view of a touch panel substrate in accordance with Embodiment 2 of the present invention.

FIG. 13 is a plan view of a touch panel in accordance with yet another example of the present invention. (a) of FIG. 13 is a plan view of a touch panel substrate in a case where a first electrode substrate and a second electrode are put on top of each other. (b) of FIG. 13 is a plan view of the first electrode substrate. (c) of FIG. 13 is a plan view of the second electrode substrate.

FIG. 14 is a plan view of a touch panel substrate in accordance with yet another example of the present invention. (a) of FIG. 14 is a plan view of the touch panel in a case where a first electrode substrate and a second electrode substrate are put on top of each other. (b) of FIG. 14 is a cross-sectional view of the touch panel substrate in a case where the first electrode substrate and the second electrode substrate are put on top of each other. (c) of FIG. 14 is a plan view of the first electrode substrate. (d) of FIG. 14 is a plan view of the second electrode substrate.

FIG. 15 is a schematic view of a touch panel disclosed in Patent Literature 2. (a) of FIG. 15 is a schematic top view of the touch panel. (b) of FIG. 15 is a cross-sectional view taken along line XX′ of (a) of FIG. 15.

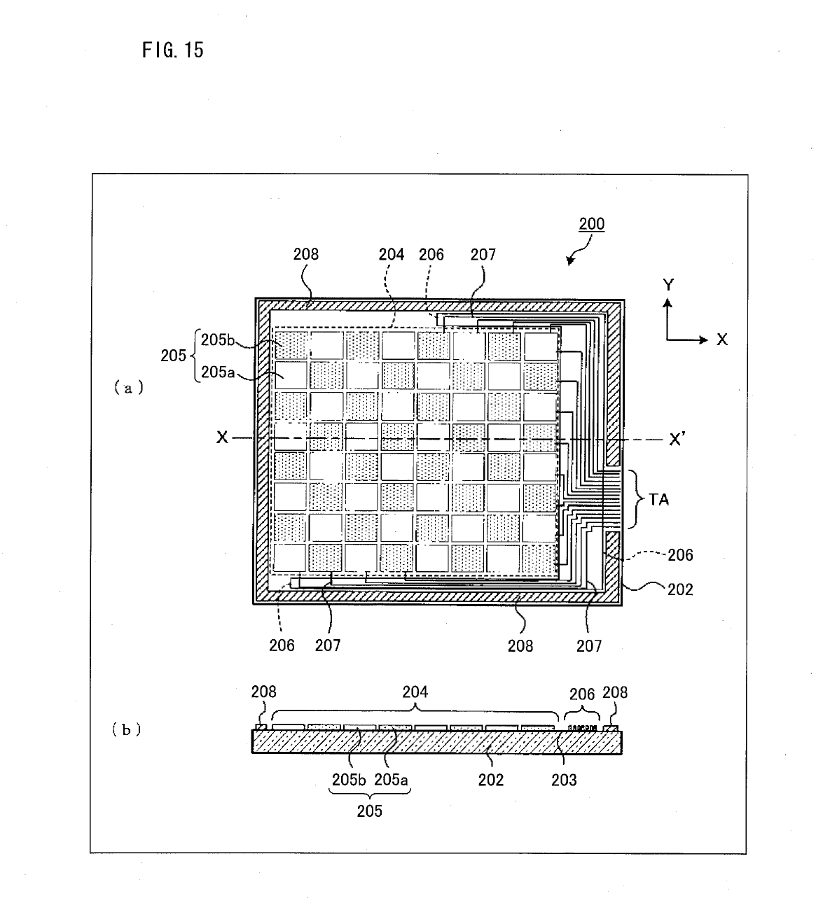

FIG. 16 is a top view of another example of the touch panel disclosed in Patent Literature 2.

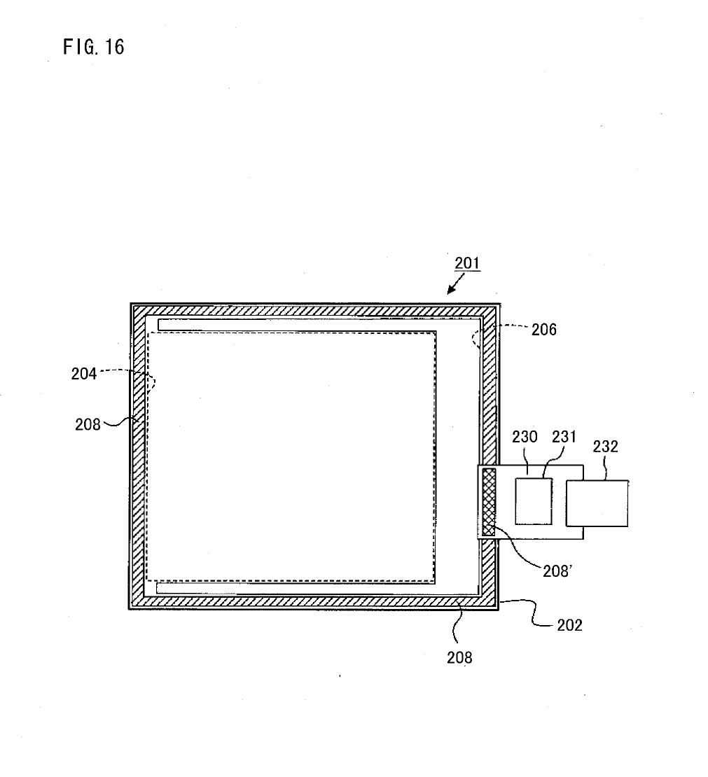

### DESCRIPTION OF EMBODIMENT

### Embodiment 1

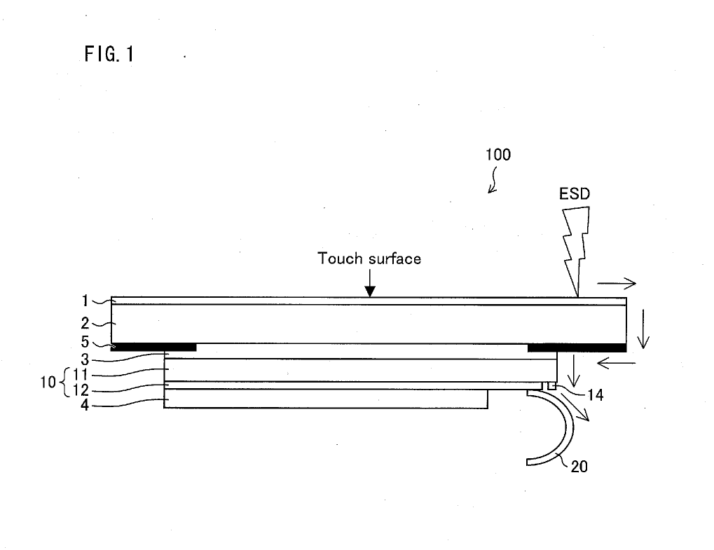

The following discusses an embodiment of the present invention in detail with reference to FIGS. 1 through 6.

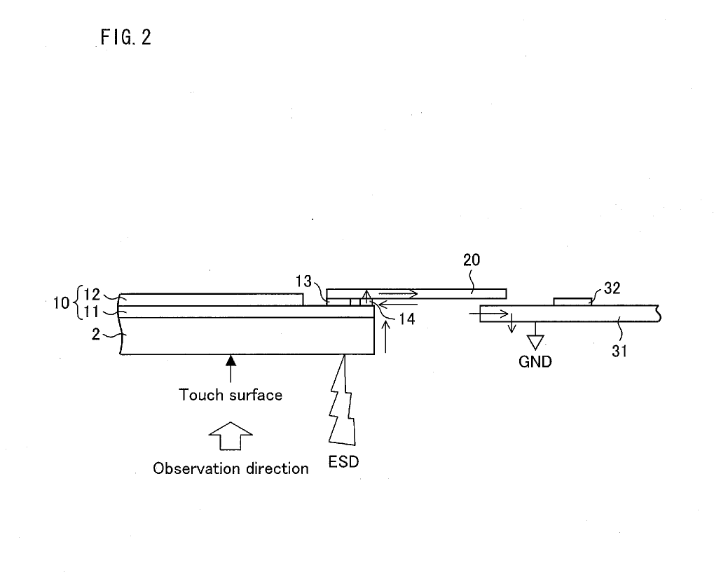

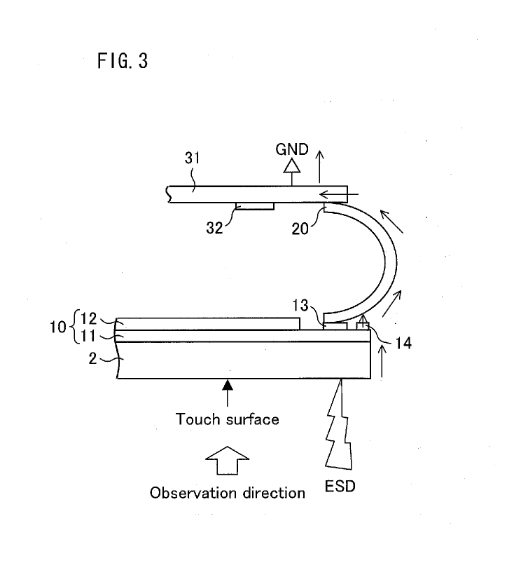

FIG. 1 is a cross-sectional view of a touch panel substrate of Embodiment 1. FIG. 2 is a cross-sectional view illustrating a connection relation between a first electrode substrate and a touch controller in the touch panel substrate of Embodiment 1. FIG. 3 is a cross-sectional view illustrating a connection relation between the first electrode substrate and the touch controller in a case where a flexible substrate is bent.

As illustrated in FIG. 1, a touch panel substrate 100 is configured to include an AR (Anti Refrection) film 1 for preventing reflection of external light, a cover glass 2, an OCA (Optical Clear Adhesive, transparent optical adhesive film) 3, a first electrode substrate 10 provided with sensor electrodes, and a protective substrate 4, which are laminated in this order.

In the touch panel substrate 100, a surface of the AR film 1 constitutes a touch surface (detection surface) for detecting a touch or an approach of a detection target object. Note that the AR film 1 is not essential in the touch panel substrate 100 of Embodiment 1. In a case where the AR film 1 is not used, a surface of the cover glass 2 constitutes the touch surface.

Hereinafter, in the touch panel substrate 100 and each member, a surface on a touch surface side is referred to as a “front surface”, and a surface on an opposite side to the front surface is referred to as a “back surface”.

The cover glass 2 is provided with a BM (Black Matrix) 5 on an outer periphery of a back surface of the cover glass 2. The BM5 provided on the back surface of the cover glass 2 covers a wiring or the like (not illustrated in FIG. 1) which is provided in the touch panel substrate 100. This can prevent the wiring or the like of the touch panel substrate 100 from being visually recognized by a user.

The protective substrate 4 is bonded to a display surface of a display device so as to be opposed to the display device. This allows the touch panel substrate 100 to be used as a display device with a touch panel substrate.

The first electrode substrate 10 includes a first substrate 11 (substrate), a plurality of sensor electrodes 12, a terminal section 13 (see FIG. 2) made of connecting terminals of the sensor electrodes 12, and a shielding electrode 14. As illustrated in FIG. 2, the sensor electrodes 12, the terminal section 13, and the shielding electrode 14 are formed on a back surface (sensor electrode formation surface) of the first substrate 11. Further, the terminal section 13 is connected with an end of a flexible substrate 20 (relay wiring). The shielding electrode 14 is provided on an outer side of the terminal section 13, on the back surface of the first substrate 11.

Further, as illustrated in FIG. 2, the touch panel substrate 100 includes a touch controller substrate 31, which is a substrate different from the first substrate 11, and a touch controller 32 (detection circuit, IC) which is provided, as an AFE (Analog Front End), on the touch controller substrate 31.

The other end of the flexible substrate 20 is connected to the touch controller 31. This electrically connects the plurality of sensor electrodes 12 and the touch controller 32 to each other. Note that the flexible substrate 20 does not necessarily have to be used as long as the sensor electrodes 12 (formed on the first substrate 11) and the touch controller 32 (formed on the touch controller substrate 31) are electrically connected to each other. For example, a rigid substrate can be used in order to connect the sensor electrodes 12 and the touch controller 32.

The flexible substrate 20 includes a grounding terminal (GND terminal) that is grounded by connection to GND of the touch controller substrate 31. The GND terminal is electrically connected to the shielding electrode 14 on the first substrate 11. This makes it possible to block static electricity by use of the shielding electrode 14 before entry of the static electricity into the terminal section 13, which static electricity comes around from a touch surface (a front surface of the AR film 1 or a front surface of the cover glass 2) to a back surface of the first substrate 11 via a side surface of the touch panel substrate 100. Further, it is possible to release the static electricity to GND potential via the GND terminal of the flexible substrate 20. This consequently makes it possible to prevent electrostatic breakdown of the touch controller 32 due to application of a voltage of the static electricity.

Note that the shielding electrode 14 does not necessarily have to be electrically connected to GND, but can be provided simply as a lightning conductor. Note also that the shielding electrode 14 can be connected to a static elimination sheet so that static electricity may be discharged into the air by using the static elimination sheet. This makes it possible to obtain a similar effect to that in a case where the static electricity charged on the shielding electrode 14 is released to GND.

Further, as illustrated in FIG. 3, the touch panel substrate 100 can be configured such that the flexible substrate 20 is folded back and that the touch controller substrate 31 and the touch controller 32 are provided on a back surface side of the first electrode substrate 10. This makes it possible to reduce a size of the touch panel substrate 100.

Between the sensor electrodes 12, electrostatic capacitance is formed. A touch or an approach of a detection target object such as a human finger causes a change in value of the electrostatic capacitance which is formed between two different types of sensor electrodes among the sensor electrodes 12. This change in electrostatic capacitance is detected by the touch controller 32. This makes it possible to identify a position where the detection target object touches or approaches on/to the detection surface of the touch panel substrate 100. Note that a well-known circuit can be used as the touch controller 32 for detecting a coordinate position of the detection target object.

The following Examples each concretely discuss an arrangement of the shielding electrode 14 in the first electrode substrate 10 according to Embodiment 1.

### EXAMPLE 1

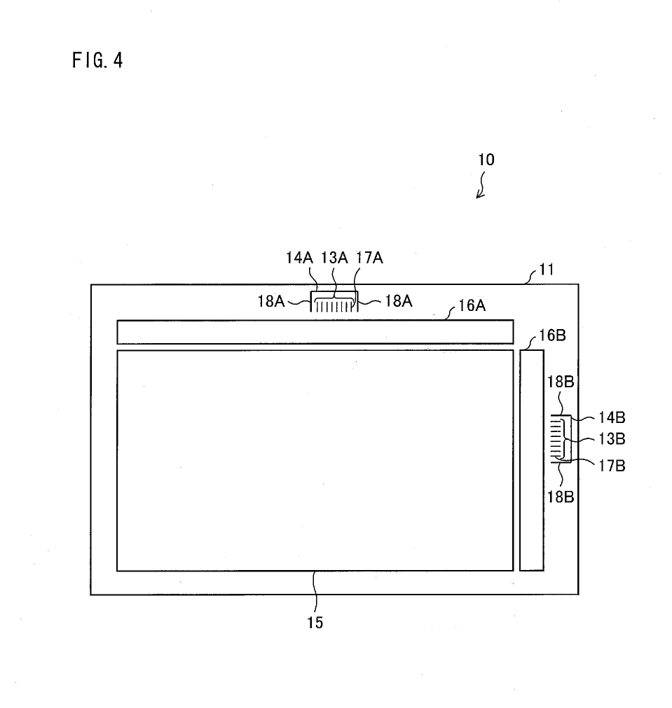

FIG. 4 is a plan view illustrating a back surface side of a first electrode substrate in accordance with an example of Embodiment 1.

As illustrated in FIG. 4, a back surface of a first substrate 11 is provided with a sensor active area 15 in which a plurality of sensor electrodes is formed. The plurality of sensor electrodes provided in the sensor active area 15 includes a plurality of first sensor electrodes formed so as to extend in a first direction and a plurality of second sensor electrodes formed to extend in a second direction orthogonal to the first direction, which first sensor electrodes and the second sensor electrodes are not illustrated in FIG. 4.

The first substrate 11 is provided, outside the sensor active area 15, a wiring area 16A for collecting lines which are connected to the first sensor electrodes, respectively, and a wiring area 16B for collecting lines which are connected to the second sensor electrodes, respectively.

Outside the wiring area 16A, a plurality of connecting terminals 17A extended from the first sensor electrodes constitutes a terminal section 13A. Meanwhile, outside the wiring area 16B, a plurality of connecting terminals 17B extended from the second sensor electrodes constitutes a terminal section 13B.

Further, the first substrate 11 is provided, on the back surface thereof, with a shielding electrode 14A on an outer side of the terminal section 13A and a shielding electrode 14B on an outer side of the terminal section 13B. The shielding electrode 14A is provided so as to cover a width of the terminal section 13A, while the shielding electrode 14B is provided so as to cover a width of the terminal section 13B. More concretely, the shielding electrodes each are provided between the terminal section and an outer edge of the first substrate 11.

The terminal section 13A is connected to an end of a flexible substrate by crimping with use of an ACF (Anisotropic Conductive Film). The terminal section 13B is connected to an end of another flexible substrate by crimping with use of the ACF.

The flexible substrate is provided with two GND terminals 18 and a plurality of electrode terminals connected to the connecting terminals 17A (17B) of the terminal section 13A (13B), respectively. The flexible substrate is connected to the back surface of the first substrate 11, in such a manner that the two GND terminals 18A are connected to the shielding electrode 14A and also sandwich the terminal section 13A. Similarly, the another flexible substrate is connected to the back surface of the first substrate, in such a manner that the two GND terminals 18B are connected to the shielding electrode 14B and also sandwich the terminal section 13B.

Accordingly, the terminal section 13A is surrounded by the two GND terminals 18A and the shielding electrode 14A. Meanwhile, the terminal section 13B is surrounded by the two GND terminals 18B and the shielding electrode 14B.

As described above, on the back surface of the first substrate 11, the shielding electrode 14A is provided on the outer side of the terminal section 13A, and the shielding electrode 14B is provided on the outer side of the terminal section 13B. Therefore, as FIG. 1 illustrates, it is possible to prevent static electricity from entering the terminal sections 13A and 13B, which static electricity comes around from the touch surface of the touch panel substrate 100 to the back surface side of the first substrate 11. As a result, it is possible to prevent a voltage of the static electricity from being applied to the touch controller 32 via the terminal section 13 and the flexible substrate 20. This consequently makes it possible to prevent electrostatic breakdown of the touch controller 32.

Note that the above discusses, with the example illustrated in FIG. 4, a case where the shielding electrodes 14A and 14B are provided only on the outer sides of the terminal sections 13A and 13B. However, the present invention is not limited to this configuration. The shielding electrodes 14A and 14B can be provided so as to entirely surround the sensor active area 15 and the wiring areas 16A and 16B.

### COMPARATIVE EXAMPLE

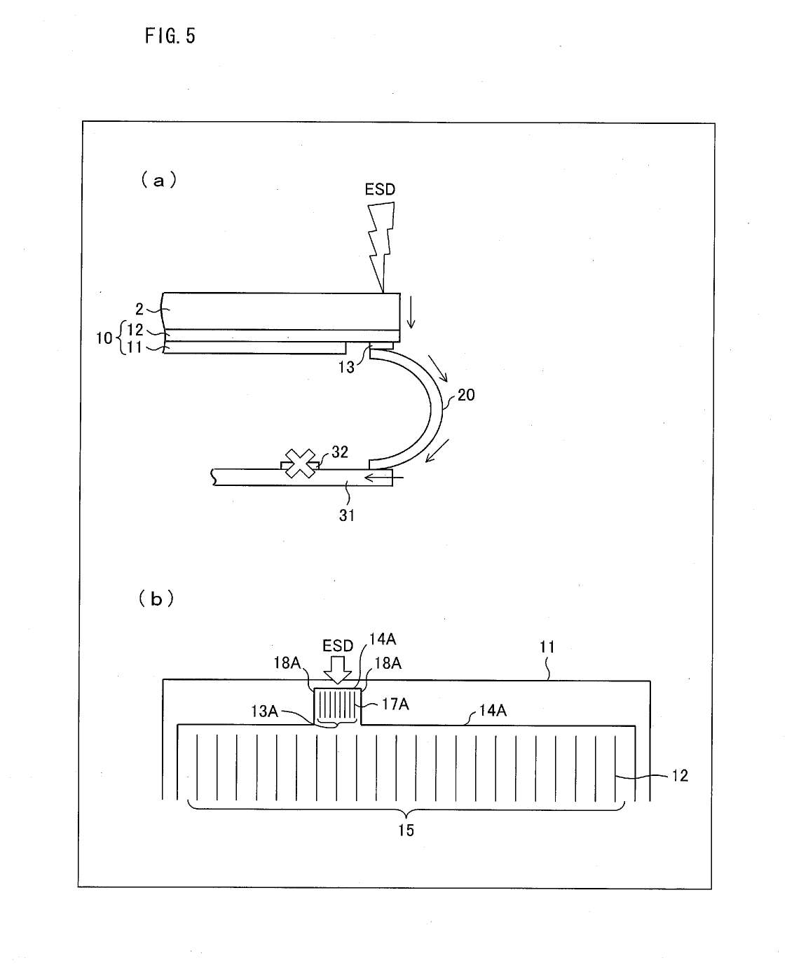

FIG. 5 is a view for illustrating paths of static electricity. (a) of FIG. 5 is a cross-sectional view of a touch panel substrate of a comparative example, which cross-sectional view illustrates a path of static electricity in a case where a first substrate is provided with no shielding electrode. (b) of FIG. 5 is a plan view of the first electrode substrate of a touch panel substrate according to Embodiment 1, which plan view illustrates a path of static electricity in a case where a first substrate is provided with a shielding electrode.

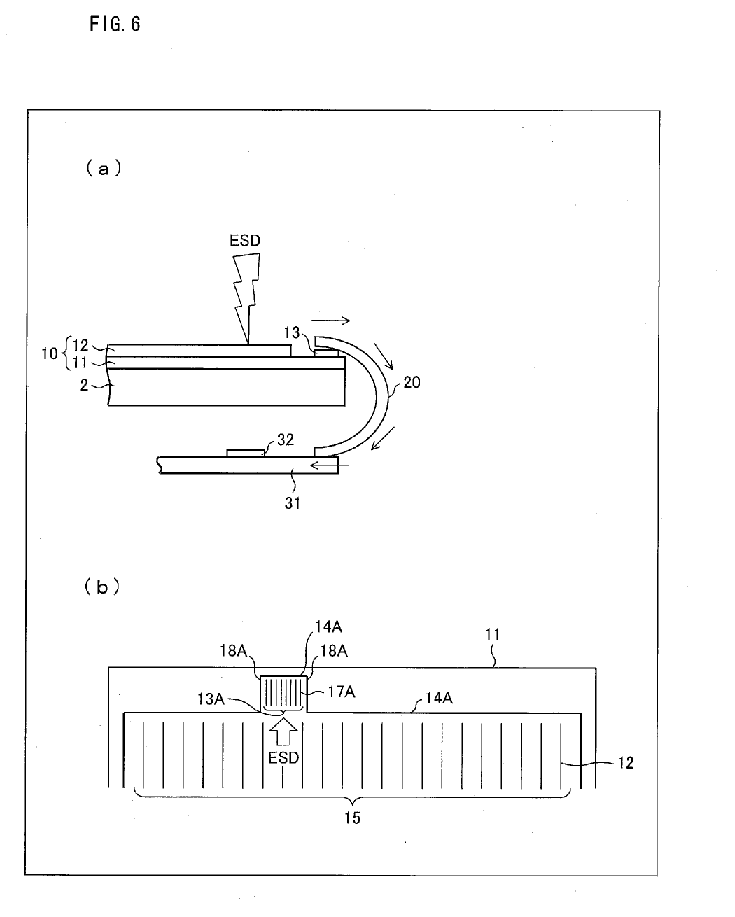

FIG. 6 is a view for illustrating paths of static electricity. (a) of FIG. 6 is a cross-sectional view of a touch panel substrate, as a comparative example, disclosed in Patent Literature 2. (b) of FIG. 6 is a plan view of a first electrode substrate of the touch panel substrate disclosed in Patent Literature 2, which plan view illustrates a path of static electricity in a case where the first substrate is provided with a shielding electrode.

For convenience of explanation, illustration of a wiring area is omitted in FIGS. 5 and 6, and subsequent figures.

As (a) of FIG. 5 illustrates, in a case where no shielding electrode is provided on a first substrate 11, for example, a touch with an electrically charged user's finger on a touch surface causes static electricity, which comes around from a touch surface to a back surface of the first substrate 11 and enters a terminal section 13. As a result, a voltage of the static electricity is applied to a touch controller 32 via the terminal section 13 and a flexible substrate 20. This consequently leads to electrostatic breakdown of the touch controller 32.

In contrast, as (b) of FIG. 5 illustrates, in a case where a shielding electrode 14A is provided on an outer side of a terminal section 13A, the shielding electrode 14A blocks the static electricity which comes around from a touch surface to a back surface of a first substrate 11. This makes it possible to prevent the static electricity from entering the terminal section 13A. Therefore, it is possible to prevent a voltage of the static electricity from being applied to a touch controller 32. This consequently makes it possible to prevent electrostatic breakdown of the touch controller 32.

Note that, in the touch panel of Patent Literature 2 having a configuration as illustrated in (a) of FIG. 6, sensor electrodes 12 are formed on a front surface of a first substrate 11. Accordingly, static electricity from outside enters a terminal portion of a terminal section 13 via the sensor electrodes 12. As a result, a voltage of the static electricity is applied to a touch controller 32 via the terminal section 13 and a flexible substrate 20. This consequently causes electrostatic breakdown of the touch controller 32.

In the case of the touch panel disclosed in Patent Literature 2, even if the shielding electrode 14A is provided on the outer side of the terminal section 13A as illustrated in (b) of FIG. 6, static electricity enters the terminal section 13A via the sensor electrodes 12 on an inner side of the shielding electrode 14A. Therefore, it is not possible to prevent a voltage of the static electricity from being applied to the touch controller 32.

### EXAMPLE 2

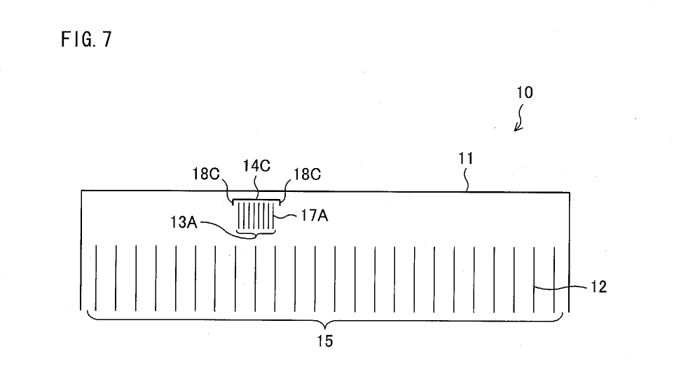

The following discusses other examples of Embodiment 1, with reference to FIGS. 7 through 11. Note that, for convenience of explanation, members having functions identical to those of respective members described in the above Examples are given identical reference signs, respectively, and descriptions thereof are omitted here.

FIG. 7 is a plan view illustrating a back surface of a first electrode substrate in accordance with another example of Embodiment 1.

A first electrode substrate 10 in accordance with Example 2 is provided with two GND terminals 18C as a result of connection of a flexible substrate to a back surface of a first substrate 11. Here, the two GND terminals 18C are provided so as to sandwich a terminal section 13A, as illustrated in FIG. 7.

The GND terminals 18C of the present embodiment are shorter than the GND terminals 18A of Example 1. The GND terminals 18C are provided so as to sandwich only an end portion of the terminal section 13A. In this way, the GND terminals 18C do not necessarily have to be provided so as to sandwich the terminal section 13A from both sides of the terminal section 13A. The GND terminals 18C only need to be provided so as to be at least connected to a shielding electrode 14C.

The first electrode substrate in accordance with Example 2, similarly to that of Example 1, can prevent a voltage of static electricity from being applied to a touch controller, and thereby prevent electrostatic breakdown of the touch controller.

### EXAMPLE 3

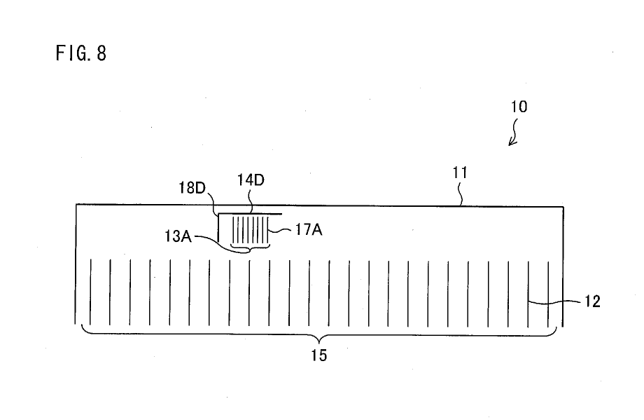

FIG. 8 is a plan view illustrating a back surface side of a first electrode substrate in accordance with yet another example of the present invention.

A first electrode substrate 10 in accordance with Example 3 is provided with a GND terminal 18D as a result of connection of a flexible substrate to a back surface of a first substrate 11. Here, the GND terminal 18D is provided along connecting terminals 17A of a terminal section 13A, as illustrated in FIG. 8. A distance between the GND terminal 18D and a connecting terminal 17A that is the closest to the GND terminal 18D is larger than a distance between adjacent connecting terminals 17A.

The first electrode substrate in accordance with Example 3, similarly to that of Example 1, can prevent a voltage of static electricity from being applied to a touch controller and thereby prevent electrostatic breakdown of the touch controller.

In addition, the first electrode substrate 10 in accordance with Example 3 can prevent the GND terminal 18D and the connecting terminals 17A from being short-circuited. Further, the first electrode substrate 10 can suppress electrostatic discharge between the GND terminal 18D and the connecting terminals 17A. This makes it possible to more effectively prevent static electricity from entering the terminal section 13.

Note that, as in configurations of Examples 1 and 2, Example 3 can be provided with two GND terminals in such a manner that the two GND terminals sandwich the terminal section 13A (this configuration is not illustrated in FIG. 8).

### EXAMPLE 4

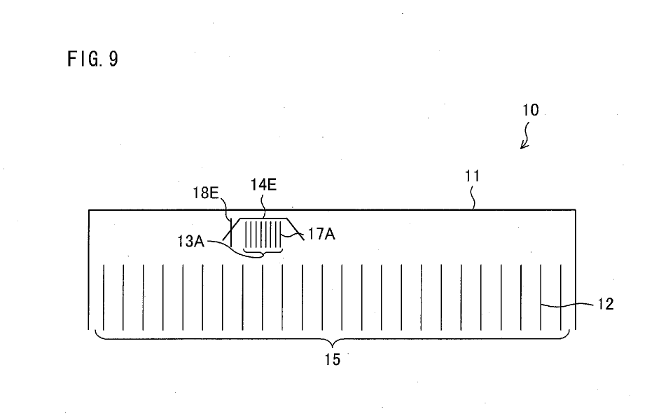

FIG. 9 is a plan view illustrating a back surface side of a first electrode substrate in accordance with yet another example of Embodiment 1.

A first electrode substrate 10 in accordance with Example 4 is provided, on a back surface of a first substrate 11, with a substantially U-shaped shielding electrode 14E which is arranged to cover an outer side of a terminal section 13A.

Further, the back surface of the first substrate 11 is connected with a flexible substrate. This forms connection between a GND terminal 18E of the flexible substrate and the shielding electrode 14E, as FIG. 9 illustrates.

The first electrode substrate in accordance with Example 4, similarly to that of Example 1, can prevent a voltage of static electricity from being applied to a touch controller and thereby prevent electrostatic breakdown of the touch controller.

Note that, as in configurations of Examples 1 and 2, Example 4 can be provided with two GND terminals in such a manner that the two GND terminals sandwich the terminal section 13A (this configuration is not illustrated in FIG. 9).

### EXAMPLE 5

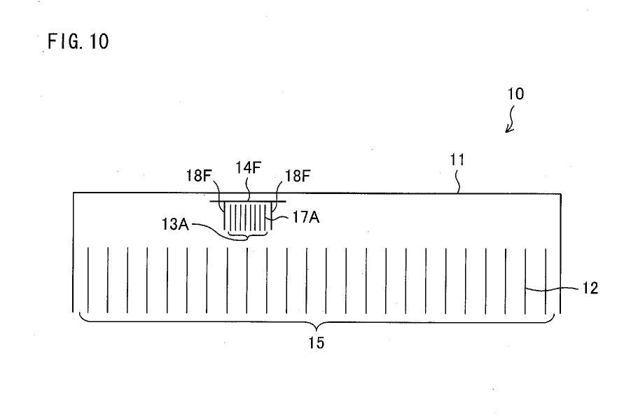

FIG. 10 is a plan view illustrating a back surface side of a first electrode substrate in accordance with yet another example of Embodiment 1.

A first electrode substrate 10 in accordance with Example 5 is provided with two GND terminals 18F as a result of connection of a flexible substrate to a back surface of a first substrate 11. The two GND terminals 18F are provided so as to sandwich a terminal section 13A, as illustrated in FIG. 10.

Further, as illustrated in FIG. 10, the two GND terminals 18F are connected to a shielding electrode 14F. The shielding electrode 14F has a length larger than a distance between the two GND terminals 18F.

The first electrode substrate in accordance with Example 5, similarly to that of Example 1, can prevent a voltage of static electricity from being applied to a touch controller and thereby prevent electrostatic breakdown of the touch controller.

### EXAMPLE 6

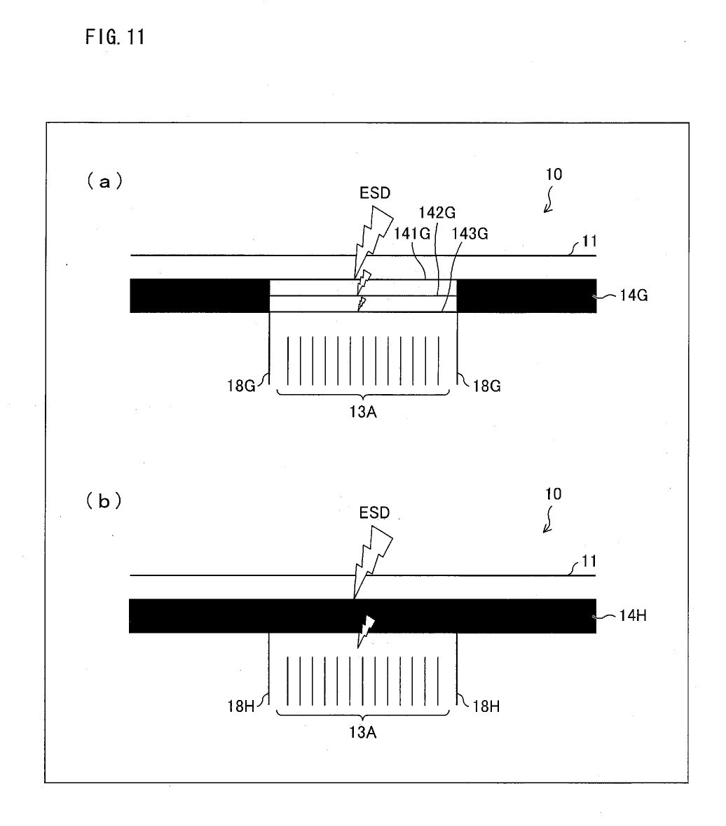

FIG. 11 is a view illustrating configurations of shielding electrodes. (a) of FIG. 11 is a plan view illustrating a back surface side of a first electrode substrate in accordance with yet another example of Embodiment 1. (b) of FIG. 11 is a plan view illustrating a back surface side of another first electrode substrate as a comparative example.

As illustrated in (a) of FIG. 11, a first electrode substrate 10 in accordance with Example 6 is provided with a shielding electrode 14G, on a back surface of a first substrate 11. At least a part of the shielding electrode 14G has a multiple structure including a first shielding electrode 141G, a second shielding electrode 142G, and a third shielding electrode 143G, in a planar view.

As (b) of FIG. 11 illustrates, in a case where only one layer of a shielding electrode 14H is provided, static electricity may leap over the shielding electrode 14H and enter an electrode section 13A.

In contrast, in the first electrode substrate 10 in accordance with Example 6, the shielding electrode 14G is multiply provided. Consequently, the shielding electrodes 141G, 142G, and 143G function as buffers against static electricity, and hence it is possible to more reliably prevent the static electricity from entering the terminal section 13A. This makes it possible to effectively prevent a voltage of static electricity from being applied to a touch controller, and thereby more reliably prevent electrostatic breakdown of the touch controller.

### Embodiment 2

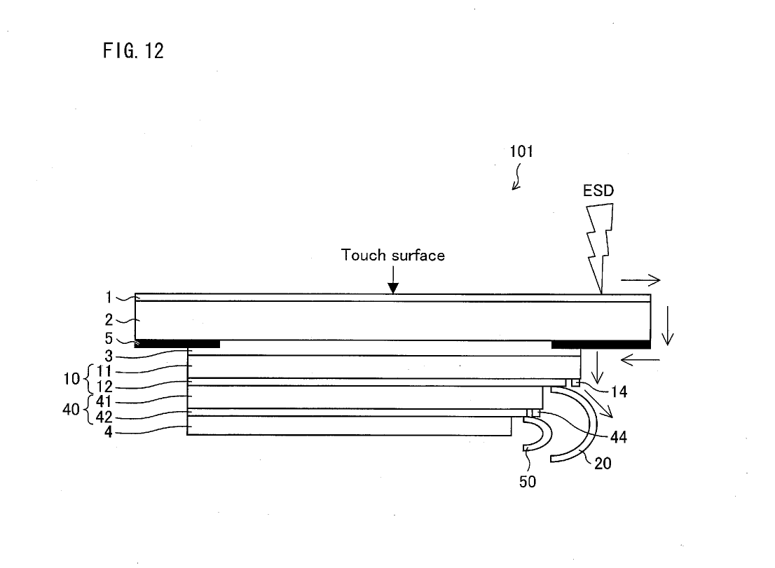

The following discusses another embodiment of the present invention, with reference to FIG. 12. Note that, for convenience of explanation, members having functions identical to those of respective members described in Embodiment 1 are given identical reference signs, respectively, and descriptions thereof are omitted here.

FIG. 12 is a cross-sectional view of a touch panel substrate in accordance with Embodiment 2.

As illustrated in FIG. 12, a touch panel substrate 101, unlike the touch panel substrate 100 according to Embodiment 1, is provided with a second electrode substrate 40 between a first electrode substrate 10 and a protective substrate 4.

The second electrode substrate 40 includes a second substrate 41 (substrate), a plurality of sensor electrodes 42, a terminal section, and a shielding electrode 44. The sensor electrodes 42, the terminal section and the shielding electrode 44 are formed on a back surface (a sensor electrode formation surface) of the second substrate 41. The terminal section including connecting terminals of the sensor electrodes 42 is connected to one end of a flexible substrate 50 (relay wiring). The shielding electrode 44 is provided on the second substrate 41, on an outer side of the terminal section.

The touch panel substrate 101 is provided with a touch controller substrate 31, which is different from a first substrate 11 and the second substrate 41, and a touch controller 32 provided on the touch controller substrate 31 (the touch controller substrate 31 and the touch controller 32 are not illustrated in FIG. 12).

The touch controller 32 is electrically connected with the other end of a flexible substrate 20 and the other end of the flexible substrate 50. This electrically connects sensor electrodes 12 and sensor electrodes 42 with the touch controller 32.

The flexible substrate 20 and the flexible substrate each are provided with a GND terminal that is electrically connected to GND of the touch controller substrate 31. The GND terminal of the flexible substrate 20 is electrically connected to a shieling electrode 14 on the first substrate 11. Meanwhile, the GND terminal of the flexible substrate 50 is electrically connected to the shielding electrode 44 on the second substrate 41.

Therefore, similarly to the touch panel substrate 100 of Embodiment 1, the touch panel substrate 101 can (i) block static electricity by use of the shielding electrodes 14 and 44 before entry of the static electricity into the terminal section, which static electricity comes around from a touch surface to a back surface of the first substrate 11 or a back surface of the second substrate 41 via a side surface of the touch panel substrate 101, and (ii) release the static electricity to GND potential via the GND terminals of the flexible substrates 20 and 50. This consequently makes it possible to prevent electrostatic breakdown of the touch controller 32 due to application of a voltage of the static electricity.

Note that a configuration of each Example of Embodiment 1 can be adopted as a configuration of the second electrode substrate 40.

### EXAMPLE 7

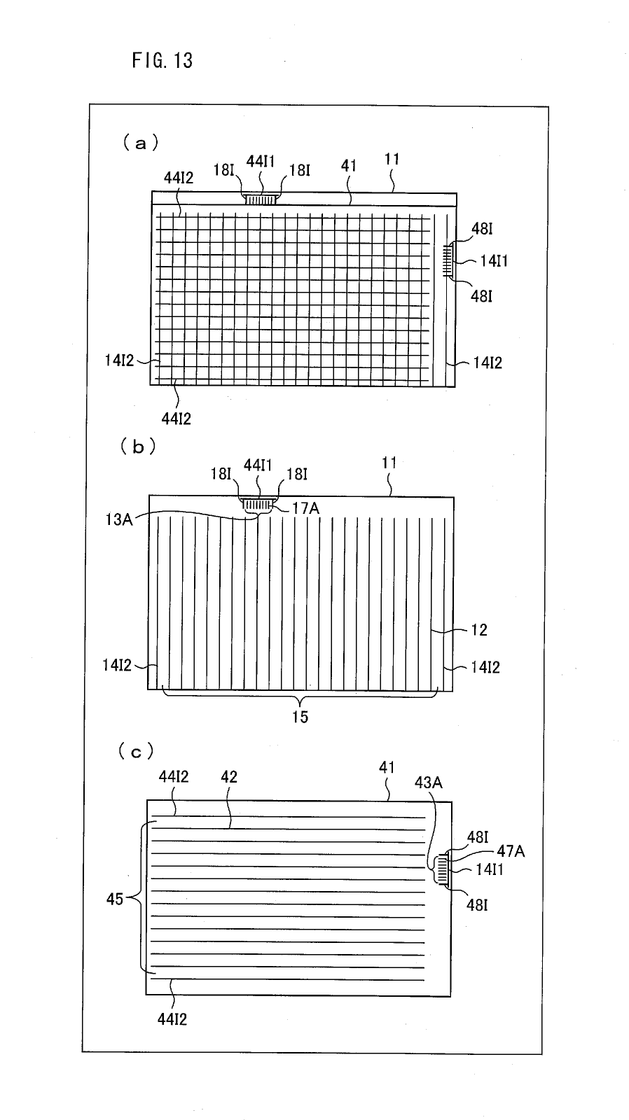

FIG. 13 is a plan view of a touch panel substrate in accordance with an example of Embodiment 2. (a) of FIG. 13 is a plan view of a touch panel substrate in a case where a first electrode substrate and a second electrode substrate are put on top of each other. (b) of FIG. 13 is a plan view of the first electrode substrate. (c) of FIG. 13 is a plan view of the second electrode substrate.

As illustrated in (b) of FIG. 13, a first substrate 11 is provided, on a back surface thereof, with a sensor active area 15 in which a plurality of sensor electrodes 12 is formed. Outside the sensor active area 15, a plurality of connecting terminals 17A extended from the sensor electrodes 12 constitutes a terminal section 13A. The first substrate 11 is further provided with a shielding electrode 4411 on an outer side of the terminal section 13A, on the back surface of the first substrate 11. The first substrate 11 is additionally provided with two GND terminals 181 in such a manner that the two GND terminals 181 sandwich the terminal section 13A.

Furthermore, the first substrate 11 is provided with two shielding electrodes 1412 substantially parallel to a direction in which the sensor electrodes 12 extend. The two shielding electrodes 1412 are provided so as to sandwich the sensor active area 15.

As illustrated in (c) of FIG. 13, a second substrate 41 is provided, on a back surface thereof, with a sensor active area 45 in which a plurality of sensor electrodes 42 orthogonal to the sensor electrodes 12 is formed. Outside the sensor active area 45, a plurality of connecting terminals 47A extended from the sensor electrodes 42 constitute a terminal section 43A. The second substrate 41 is further provided with a shielding electrode 1411 on an outer side of the terminal section 43A, on the back surface of the second substrate 41. The second substrate 41 is additionally provided with two GND terminals 481 in such a manner that the two GND terminals 481 sandwich the terminal section 43A.

Furthermore, the second substrate 41 is provided with two shielding electrodes 4412 substantially parallel to a direction in which the sensor electrodes 42 extend. The two shielding electrodes 4412 are provided so as to sandwich the sensor active area 45.

In a touch panel substrate 101 of Example 7, as illustrated in (a) of FIG. 13, the shielding electrodes 1412 run in a layer below the terminal section 43A in a case where the first electrode substrate 10 and the second electrode substrate 40 are put on top of each other. In other words, in a planar view, the terminal section 43A overlaps the shielding electrodes 1412.

The touch panel substrate in accordance with Example 7, similarly to that in Example 1, makes it possible to prevent a voltage of static electricity from being applied to a touch controller and thereby prevent electrostatic breakdown of the touch controller.

### EXAMPLE 8

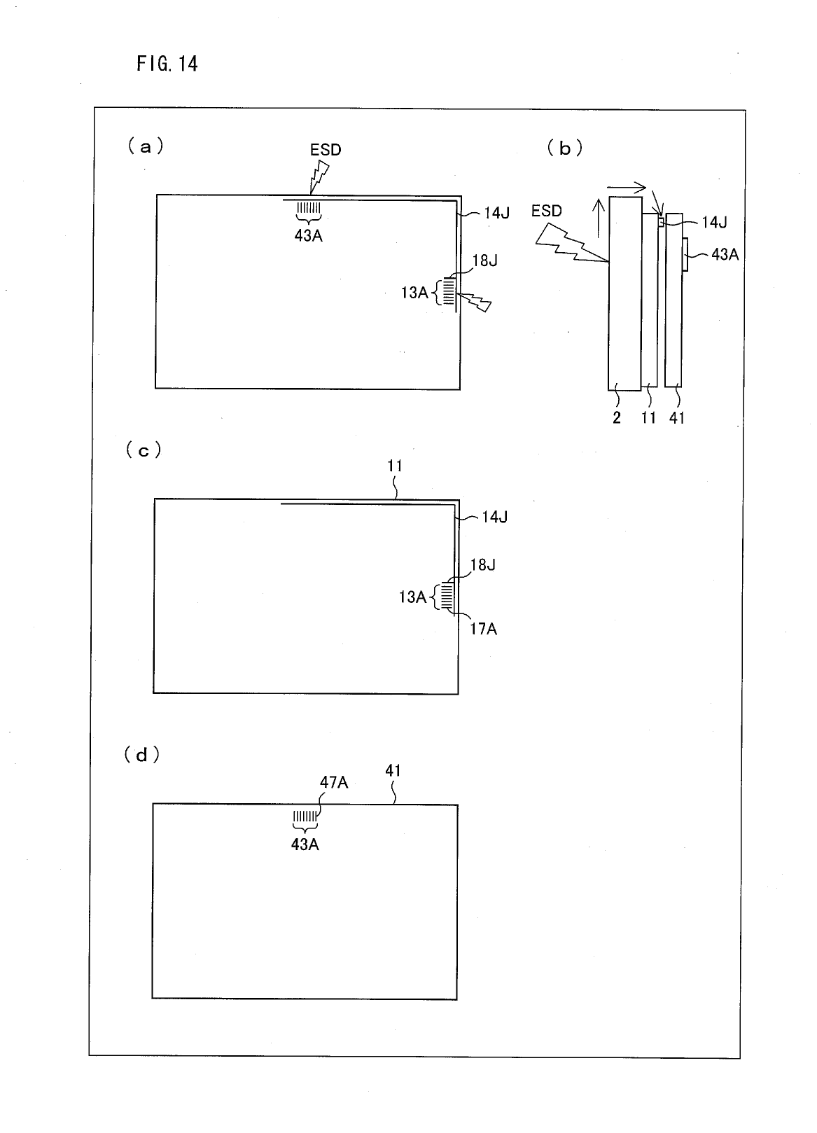

FIG. 14 is a plan view of a touch panel substrate in accordance with Example 8. (a) of FIG. 14 is a plan view of the touch panel substrate in a case where a first electrode substrate and a second electrode substrate are put on top of each other. (b) of FIG. 14 is a cross-sectional view of the touch panel substrate in a case where the first electrode substrate and the second electrode substrate are put on top of each other. (c) of FIG. 14 is a plan view of the first electrode substrate. (d) of FIG. 14 is a plan view of the second electrode substrate. Note that, for simplification of explanation, illustration of sensor electrodes is omitted in FIG. 14.

As illustrated in (b) of FIG. 14, a cover glass 2 constituting a touch surface, a first substrate 11, and a second substrate 41 are provided in this order.

As illustrated in (c) of FIG. 14, the first substrate 11 is provided, on a back surface thereof, with a terminal section 13A constituted by a plurality of connecting terminals 17A which are extended from sensor electrodes. Moreover, the first substrate 11 is provided with a shielding electrode 14J which is formed on an outer side of the terminal section 13A. Further, the first substrate 11 is provided with a GND terminal 18J which is connected to the shielding electrode 14J. The GND terminal 18J is formed along the connecting terminals 17A.

As illustrated in (d) of FIG. 14, the second substrate 41 is provided, on a back surface thereof, with a terminal section 43A constituted by a plurality of connecting terminals 47A which are extended from sensor electrodes.

The first substrate 11 and the second substrate 41 are bonded to each other as illustrated in (a) of FIG. 14.

In the touch panel substrate of Example 8, the shielding electrode 14J and the GND terminal 18J are formed only on the first substrate 11 which is closer to the cover glass 2 than the second substrate 41.

Even in a case where neither a shielding electrode nor a GND terminal is formed on the second substrate 41, it is possible to release, to GND potential via the shielding electrode 14J, a voltage of static electricity which is applied to a touch surface, as illustrated in (b) of FIG. 14. Hence, no static electricity enters the back surface of the second substrate 41. This makes it possible to prevent a voltage of static electricity from being applied to a touch controller via the terminal section and a flexible substrate, and thereby prevent electrostatic breakdown of the touch controller.

Further, in the touch panel substrate of Example 8, it is possible to reduce production cost because neither a shielding electrode nor a GND terminal is required to be formed on the second substrate 41.

### CONCLUSION

A touch panel substrate in accordance with Aspect 1 of the present invention is a touch panel substrate for detecting a position of a detection target object on a detection surface (touch surface) which faces outside, the touch panel substrate including: a substrate (first substrate 11, second substrate 41) provided with a plurality of sensor electrodes (12, 42); a detection circuit (touch controller 32) electrically connected to the sensor electrodes; and a relay wiring (flexible substrate 12, 50) for electrically connecting the sensor electrodes and the detection circuit to each other, the sensor electrodes being provided on a sensor electrode formation surface of the substrate, the sensor electrode formation surface being a surface on an opposite side of the detection surface, the sensor electrode formation surface being provided with a terminal section (13, 43) including terminals of the sensor electrodes, the relay wiring having one end connected to the terminal section, and the sensor electrode formation surface being provided with a shielding electrode (14, 44), on an outer side of the terminal section.

The above configuration makes it possible to block static electricity by use of the shielding electrode before entry of the static electricity into the terminal section, which static electricity comes around from a side surface of the touch panel substrate to the sensor electrode formation surface of the substrate. For example, it is possible to block, by use of the shielding electrode, static electricity which has been caused by a touch with an electrically charged finger on the detection surface and comes around from the detection surface to a sensor electrode formation surface side.

This makes it possible to prevent a voltage of static electricity from being applied to the detection circuit via the terminal section and the relay wiring. This consequently makes it possible to prevent electrostatic breakdown of the touch controller 32 due to application of a voltage of the static electricity.

A touch panel substrate in accordance with Aspect 2 of the present invention can be configured such that in the above Aspect 1, the relay wiring is a flexible substrate that is bendable.

In the above configuration, there is no limitation in position where the detection circuit is provided to the sensor electrode formation surface, within a movable range of the flexible substrate. This makes it possible to reduce a size of the touch panel substrate by, for example, providing the detection circuit on a back surface of the substrate.

A touch panel substrate in accordance with Aspect 3 of the present invention can be configured such that, in the above Aspect 1 or 2, the shielding electrode is grounded.

The above configuration makes it possible to release, to GND, static electricity which has been blocked by use of the shielding electrode.

A touch panel substrate in accordance with Aspect 4 of the present invention can be configured such that, in the above Aspect 3, the relay wiring is provided with a ground terminal connected to the shielding electrode; and on the sensor electrode formation surface, the sensor electrodes and the terminal section are surrounded by the shielding electrode and the ground terminal.

The above configuration makes it possible to more effectively block static electricity which is about to enter the sensor electrode formation surface.

A touch panel substrate in accordance with Aspect 5 of the present invention can be configured such that, in any one of the above Aspects 1 through 4, on the sensor electrode formation surface, at least part of the shielding electrode is multiply provided in a planar view.

The above configuration makes it possible to more reliably block static electricity which is about to leap over the shielding electrode and enter the sensor electrode formation surface.

A touch panel substrate in accordance with Aspect 6 of the present invention can be configured to further include: a second substrate provided so as to face the substrate, the second substrate being provided on an opposite side of the detection surface with respect to the substrate, the sensor electrode formation surface of the substrate being provided with the sensor electrodes which are formed so as to extend in a first direction, and the second substrate being provided with second electrodes which are formed so as to extend in a second direction orthogonal to the first direction, in any one of the above Aspects 1 through 5.

The shielding electrode provided on the substrate closer to the detection surface blocks static electricity which comes around from the detection surface to the sensor electrode formation surface side. Therefore, there is no need to provide a shielding electrode on the second substrate farther from the detection surface, for the purpose of blocking the static electricity which comes around from the detection surface to the sensor electrode formation surface side. This makes it possible to simplify a configuration for blocking static electricity because there is no need to provide any shielding electrode on the second substrate.

The present invention is not limited to the description of the embodiments above, but may be altered by a skilled person within the scope of the claims. An embodiment based on a proper combination of technical means disclosed in different embodiments is encompassed in the technical scope of the present invention. Further, a new technical feature can be formed by combining technical measures disclosed in the embodiments.

### INDUSTRIAL APPLICABILITY

The present invention can be applied to a touch panel substrate for use in portable telephones, laptops, and the like.

### REFERENCE SIGNS LIST

11 First substrate (substrate)

41 Second substrate (substrate)

12, 42 Sensor electrode

13, 13A, 13B, 43A Terminal section

14, 14A to J, 44, 441 Shielding electrode

17A, 17B, 47A Connecting terminal

18, 18A to 18J, 481 GND terminal

20, 50 Flexible substrate

32 Touch controller (detection circuit)

100, 101 Touch panel substrate

1. A touch panel substrate for detecting a position of a detection target object on a detection surface which faces outside, the touch panel substrate comprising:
a substrate provided with a plurality of sensor electrodes;
a detection circuit electrically connected to the sensor electrodes; and
a relay wiring for electrically connecting the sensor electrodes and the detection circuit to each other,
the sensor electrodes being provided on a sensor electrode formation surface of the substrate, the sensor electrode formation surface being a surface on an opposite side of the detection surface,
the sensor electrode formation surface being provided with a terminal section including terminals of the sensor electrodes,
the relay wiring having one end connected to the terminal section, and
the sensor electrode formation surface being provided with a shielding electrode, on an outer side of the terminal section.

2. The touch panel substrate as set forth in claim 1, wherein the relay wiring is a flexible substrate which is bendable.

3. The touch panel substrate as set forth in claim 1, wherein the shielding electrode is grounded.

4. The touch panel substrate as set forth in claim 3, wherein:
the relay wiring is provided with a ground terminal connected to the shielding electrode; and
on the sensor electrode formation surface, the sensor electrodes and the terminal section are surrounded by the shielding electrode and the ground terminal.

5. The touch panel substrate as set forth in claim 1 wherein, on the sensor electrode formation surface, at least part of the shielding electrode is multiply provided in a planar view.

6. The touch panel substrate as set forth in claim 1, further comprising:
a second substrate provided so as to face the substrate, the second substrate being provided on an opposite side of the detection surface with respect to the substrate,
the sensor electrode formation surface of the substrate being provided with the sensor electrodes which are formed so as to extend in a first direction, and the second substrate being provided with second electrodes which are formed so as to extend in a second direction orthogonal to the first direction.
